(19) United States
(12) Patent Application Publication
(10) Pub. No.: US 2014/0040038 A1
(43) Pub. Date: Feb. 6, 2014

(54) Consumer oriented method and system for preference management

(71) Applicants: James Hermanowski, Waterbury, VT (US); Sherri Hermanowski, Waterbury, VT (US); Ashley Hermanowski, Waterbury, VT (US); James Hermanowski, Waterbury, VT (US); Henre Hermanowski, Waterbury, VT (US)

(72) Inventors: James Hermanowski, Waterbury, VT (US); Sherri Hermanowski, Waterbury, VT (US); Ashley Hermanowski, Waterbury, VT (US); James Hermanowski, Waterbury, VT (US); Henre Hermanowski, Waterbury, VT (US)

(21) Appl. No.: 13/566,340

(22) Filed: Aug. 3, 2012

(51) Int. Cl. G06Q 30/02

(52) U.S. Cl. 705/14.66

(57) ABSTRACT

A consumer oriented method and system for product preference management is disclosed where the consumer explicitly communicates product preferences and reasoning for such preferences allowing marketers, advertisers, distributors and manufacturers to directly understand said consumer desires. The data provided by such system being invaluable to marketers, advertisers, distributors and manufacturers allows them to modify their products to make them more attractive to the specific tastes of the consumer and to build consumer loyalty. The preference management system allows, if a consumer desires, to filter undesired advertising communication from the other parties.

### BACKGROUND OF THE INVENTION

Real world shopping of consumer goods such as groceries, electronic devices, office supplies and automobiles, insurance, financial instruments, among other items, involves the consumer sorting through a myriad of advertisements, brochures, coupons, fliers and other material to make informed decisions or change preferences. This process occurs regularly and often without notice by many consumers. Grocery shopping, for example, often involves a consumer entering a grocery store, searching through advertisements announced in the store circular, sorting through coupons obtained from the newspaper, reading item descriptions on packaging and on shelves and checking pricing. The consumer is going through a complex process of selectively ignoring advertisements for some items while paying attention to those advertisements for items which are preferred. The consumer may have developed a strong preference for an item, for example Heinz catsup, and would be entirely unwilling to consider any other brand at any price or under any condition. It is the complexity of the processes used by consumers when they establish product preferences that lead advertisers to use so many methods to try to change those preferences. Consumers, meanwhile, work very hard, consciously and subconsciously, to digest those advertisements or avoid them completely.

Consumers are constantly flooded with an array of communications meant to capture their attention, alter their preferences and win their business. In 2009, the United States Postal Service reported $17.4 billion dollars were spent to mail advertising materials. This represented 25% of all postal service income. Outside the mail system, grocery stores such as Shaws, stores such as Staples, Wal-Mart, Sears, sporting goods companies and many other businesses print weekly advertising circulars at great expense. Nationally, Sunday newspapers are loaded with printed advertisements, coupons, and announcements for a host of products and services further flooding the consumer with information. Households are constantly bombarded with phone calls from sophisticated automated dialing machines trying to reach consumers at moments when the advertiser feels the consumer would be most receptive to their persuasion. Advertisements are shown at specific times during television shows and between shows. The advent of the Internet has spawned many new ways to place information in front of the consumer. Websites now contain advertisements that pop up when the page is opened, or drop down if a mouse cursor is brought near an object on the screen. Web pages have areas off to the side of the main page called side bars loaded with advertisements. Finally, electronic communication has brought yet another onslaught of advertisements which target consumer work, home and mobile email, text messages and social websites. These undesired forms of communication are often referred to as spam.

Most of the information presented to the consumer is not applicable to them, is of little interest or takes too much time to sort through for useful information. The unprecedented flood of information placed in front of consumers can sometimes result in a problem called information overload. Information overload is a situation where too much information creates sensory overload, prevents understanding and delays a decision. In fact, consumers have demanded solutions to prevent the most intrusive approaches used by advertisers. The United States has implemented a “do not call” system which allows consumers to opt out of telemarketing programs. Other products allow consumers to skip television commercials. Software companies have created pop up blockers and other technologies which prevent obnoxious behavior of websites. Other software known as spam filters blocks unwanted electronic mail. Many companies recognizing consumer frustration have adopted approaches that allow the consumer to opt in or opt out of receiving certain advertising while signing up for services.

Marketers, advertisers, manufacturers, distributors, friends, politicians, doctors, sales people, and others, collectively referred to as influencers, are interested in persuading the consumer towards certain preferences. It is reported that these influencers spend roughly $412 billion dollars annually on advertising. Additionally, influencers are reported to spend another six billion dollars on market research. The research includes studies relating to consumer usage and attitude, brand tracking, qualitative focus groups, and media audience research. Market research is intended to allow influencers to deduce and qualify preferences which allow them to devise new methods to influence the consumer. The money spent on research shows a lack of direct understanding of consumer preferences on a large scale.

Some consumers look to the World Wide Web, or internet to search for the items they prefer or to research products. Internet searching requires significant active engagement of the consumer. The consumer must search for their preferred items and then sort through the multiple available items to narrow the selections to the ones with the best fit to their preferences. Product research using the internet requires is a laborious effort.

Auctions and reverse auctions are another approach. In this case, the consumer makes a tender for a specific product or products and then bidders make offers to win the business. In both cases, there is an expectation for the consumer to make a decision and purchase an item or items. Additionally, these systems revolve around pricing mechanisms which are intended to either maximize the purchase price, as in auctions; or minimize the purchase price as in reverse auctions. In the case of groceries and staple goods such as milk, bread, eggs and such, there is little incentive for bidders to offer products to consumers at declining prices as margins on these products are often already very low as reported for grocery store businesses in general. Reverse auctions have found true benefit in cases where supply and demand are not in balance. Bidding is attractive if, for example, the volume of business from the reverse auction is substantial enough to counter the relatively low margin that would be expected from such an auction, as with major construction projects and capital equipment projects. Meanwhile, supply and demand are in relative balance for many consumer products removing any potential benefit to the consumer from reverse auctions. In particular the law of supply and demand for items with a specific shelf life or short shelf life, such as groceries, will drive towards balance to reduce losses and waste from the system. More importantly, these approaches do nothing to allow the consumer to manage their preference for certain products or product characteristics or effectively reduce exposure to undesired advertisements nor will they allow the consumer to effectively communicate a desire for products or features which do not yet exist.

Social websites, such as Facebook and MySpace, allow users to list or show their preferences for certain products or types of products as well as make friends, and join groups of others with common interests. Marketing organizations, advertisers and others have found ways to collect and mine information from social networks and the internet to glean customer preferences and attitudes at considerable effort and cost.

As apparent from the above examples a need exists which allows the consumer to express his or her desires and preferences in such a way as to reduce the amount of exposure to information and advertisements that are unlikely to be of interest to the consumer. Another need exists for influencers to develop a direct understanding of their markets and potential customers not just to persuade a consumer regarding existing products but to readily identify the need for products which do not yet exist. Another need is for a system which allows the consumer to easily organize and filter advertisements such that only information the consumer feels useful is communicated.

### SUMMARY OF THE INVENTION

The present invention addresses the problems previously outlined by providing a consumer oriented infrastructure allowing the consumer to effectively communicate via the preference management system interest in certain items, the reasons for specific consumer preferences and the requirements that must be met before the consumer is willing to change a preference. The preference management system allows the consumer to filter information according to rules defined by the consumer.

Embodiments of the present invention reduce or eliminate the need for marketers, distributors, manufacturers, retailers, advertisers, political entities, doctors, investment advisors, sales people, and others, collectively referred to as influencers, to guess, estimate, calculate, or derive consumer preferences. The preference management system offers influencers direct access to valuable information relating to consumer preferences.

Embodiments of the present invention include a preference management system consisting of consumers, influencers and a preference management engine and database system. A consumer is an individual or group which has identified items of interest. An item of interest could be a real object such as an automobile, a grocery item such as mustard, a financial instrument such as a stock or it can be an intangible object such as a political belief or political position. Influencers are individuals or groups such as friends, advertisers, political entities, financial advisers, distributors, manufacturers, marketers, sales people, or distributors which have an interest to understand and potentially change and or reinforce the items of interest to the consumer or the consumer preferences. The preference management engine and database system is used to store consumer information, including items of interest, consumer preferences, reasons for consumer preferences and limits required to adjust consumer preference. The preference management system presents to influencers information regarding the consumer and allows the consumer to control which influencers have the ability to communicate with the consumer, when the influencer can communicate and what the influencer can communicate. The database system collects and stores information relating to items of interest to the consumer and report back to the consumer information that is relevant to them.

A feature of the preferred embodiments is that the consumer gains the advantage of computer automation to the process of filtering down myriad advertisements and communications to only those that relate to established interests. The automation mimics actions the consumer takes under normal conditions filtering and ignoring those things which are not relevant and passing on those things which are of interest to the consumer. Using the preference management system the consumer expresses interest in items which may not exist, allowing influencers to develop a new item to satisfy the interest or to modify an existing item to gain consumer interest. The consumer reaps the psychological rewards by managing the market to serve his/her interests and saves considerable time and/or effort by reducing communication from influencers to only those of true potential interest.

In embodiments of the present invention, influencers gain access to detailed information relating to consumer preferences, reasons for the preferences and barriers to change preferences. The preference management system enables influencers to modify products to win new customers and create new products and services with a known market and at minimal risk. The information, directly from the consumer, allows influencers to focus on gaining acceptance of products by using approaches other than price, especially for real goods and services. Influencers can win customer preference by focusing on non-price related features such as flavors, packaging size, packaging type, calories, fiber content, concentration, style, service level, warranty, thickness, environmental properties, corporate social responsibility and so on. Some of these features may actually allow the influencer to charge a premium for an item.

A further feature of the present invention is that the consumer also enjoys the convenience of a permanent repository of his/her preferences and associated information and rules making tasks such as shopping, grocery shopping, or searching for products much easier as irrelevant information is filtered by design.

In preferred embodiments of the present invention, the preference management system allows processing of transactions or linking to other computer systems which can process transactions which may be related to the preferences of the consumer, for example by facilitating registration to a particular political party, to process order transactions for real goods and groceries, to schedule appointments, to publish events, generate reports, or update financial data. For example, the consumer can define a preference for or actual ownership of a certain item allowing either the preference management system or an influencer a means to contact the consumer via an alert if the item is recalled, defective, discontinued or due to expire.

### BRIEF DESCRIPTION OF THE DRAWINGS

FIG. 1 is a system for practicing the methods of the invention according to an embodiment of the present invention.

### DESCRIPTION OF THE PREFERRED EMBODIMENTS

The present inventions now will be described more fully hereinafter with reference to the accompanying drawings, in which some examples of the embodiments of the invention are reviewed.

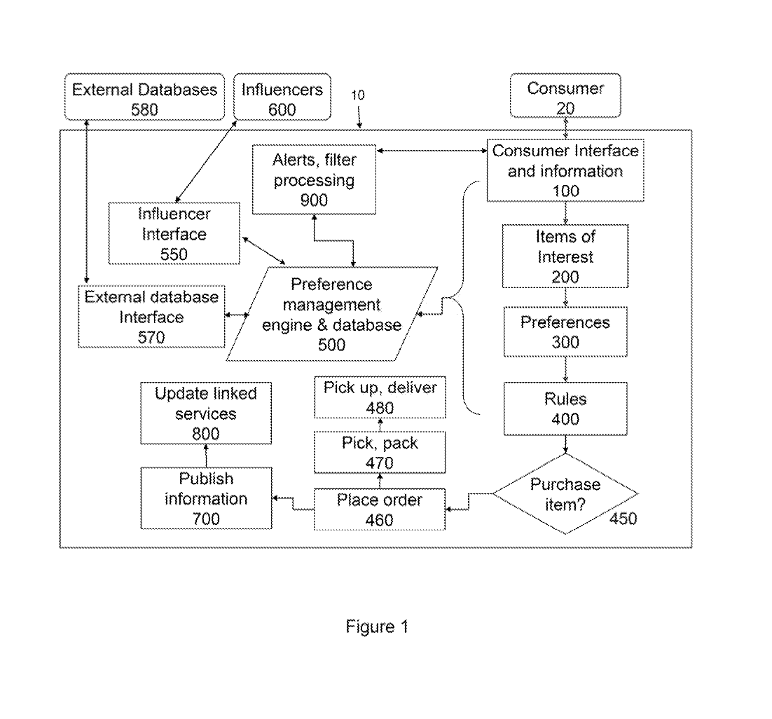

In an embodiment of the present invention, the preference management system is facilitated via a computer database system running on a network platform, such as the Internet, through specially designed software and hardware (e.g., server) configurations. Each of the parties to the preference management system are able to login to the system via appropriate hardware, e.g. personal computers (PCs), wireless or non-wireless personal digital assistants (PDAs), cellular phone, database interface, network appliances and any other appropriate merchant or consumer terminals. Further, certain embodiments of the present invention are voice enabled and run on a voice activated application. Other embodiments of the present invention are bar code scanner enabled and run on bar code scanner hardware and software. The state of the art is such that one skilled in the art is able to design appropriate hardware and software configurations to facilitate the processes described herein without undue experimentation. FIG. 1 is a system schematic for implementing the processes described herein. The preference management system 10 includes a database and preference management engine 500 which receives/retrieves information from at least consumers 20 and influencers 600. The preference management database 500 allows interconnection to external databases 580 through an external database interface 570 in order to facilitate information exchange with master item databases (e.g., Stock Keeping Units, SKU information, Universal Product Code, UPC information, International Standard Book Number, ISBN information), to retrieve data from the Internet and to conduct transactions such as order processing, credit checks, delivery scheduling, calendar updating and financial reporting. Product information may also be entered into the preference database 500 via a parser. Programs for parsing are well known to those skilled in the art.

Consumer information 100 such as name, identification number, address, and electronic mail address, can be provided by the consumer 20 via the consumer interface 100 where it is stored in the preference management database 500 to be acted upon by the preference management engine 500. The consumer 20 also provides their items of interest 200, preferences 300 which include reasons for the preferences, and rules for preferences 400 which are stored in the preference management database 500 to be acted upon by the preference management engine.

Influencers 600 can retrieve information from the preference management system 10 via database 500 using the influencer interface 550 or using the external database interface 570. Influencers can use the information gained from the preference management database to formulate plans to change the preferences of the consumer, reinforce consumer preferences or pool the information from multiple consumers to develop customized profiles, for example relating to a particular geographic region, by common interests, or by income level. The information from the preference management system can be used in a multitude of ways such as known to those experienced in the art will recognize. Influencers can directly contact the consumer/s via the preference management engine 500 through the alert and filter processing unit 900. The alert unit 900 passes influencer information to the consumer according to the rules defined by the consumer in the rules for preferences unit 400. Information which does not comply with the rules is blocked from passing to the consumer. The consumer can decide how to react to the new information, e.g., by changing items of interest, changing preferences, changing rules, taking no action or deciding to make a purchase.

In cases where the item is such that it can be purchased, the preference management system allows the consumer to place an order 460, arrange for picking and packing 470 and arrange for delivery or pick up 480 as may be defined by the customer preferences. Furthermore, the preference management system allows information to be published via publishing module 700 which can, for example, print a receipt, create a task or update a calendar. Additionally, the preference management system update linked services module 800 is available to send updates to other systems, e.g., financial software, calorie/nutrition reports, trend charts, electronic mail systems or bank accounts. In a further embodiment, the preference management system includes applications for organizing and analyzing history information into graphs, timelines, etc., in order to reflect a consumer's preference habits.

In an embodiment of the present invention, a politician enters his/her information into the preference management system such as items of interest, preferences, reasons for preferences and requirements to change his position which are then available for all his constituents, or influencers, to access. For example, the politician may have a particular view relating to an upcoming vote to increase a state sales tax, why he has such a view and the conditions under which he would consider changing his position. His/her constituents access the information and develop a campaign to ensure their representative accurately reflects their interests in the upcoming vote.

In an another embodiment of the present invention, a citizen enters his/her political information into the preference management system such as items of interest, preferences, reasons for preferences and requirements to change his position which are then available for his representative and other potential influencers, to access. For example, the citizen may have a particular view relating to an upcoming election for a state senator, why he has such a view and the conditions under which he would consider changing his position. Potential candidates and other influencers access the information of this particular citizen as well as numerous other citizens and calculate the political interests and preferences of their population of constituents. This information can be used by candidates to align their political positions to their constituent base, to develop arguments which will persuade their constituents to accept the view of the candidate or by third parties who wish to influence the citizen.

In another embodiment, a consumer is interested in purchasing an entertainment system with DVD player. He/she enters into the preference management system the types of features he is interested, reasons for the interest and actions required to change said preferences. He does not have time or want to search through stores or the internet for the entertainment system. He specifies that he prefers an entertainment system with a single Blue Ray™ DVD player because he wants to run high definition video, he specifies an HDMI connection from the entertainment system to the television because his television requires this connection, he specifies rear wireless speakers because he cannot run wires through his apartment and he specifies two hundred watts of Dolby™ stereo capability because he wants to fill the room with sound. Influencers access his preference information from the preference management system and develop plans to educate the consumer. The vast amounts of information relating to entertainment systems that do not meet his requirements are screened by the preference management system according to the rules established by the consumer. The consumer can review the feedback from the remaining influencers to help him make a purchase decision saving time and effort while meeting his goals for product features.

In another embodiment, a consumer is interested in purchasing groceries but does not wish to search through advertisements, store fliers, and myriad other documents. He/she selects from a menu of recipes for meals presented by the preference management system 10 via the consumer interface 100, he selects the meals he prefers, how many to feed and when he plans to eat the meals. The preference management system converts the selected menu items into recipes and finally into a list of ingredients which becomes the consumer's items of interest 200. The information in the preference management system is then used to select his preferred items for groceries. For example, he needs mustard and prefers Gulden brand mustard in an eight ounce plastic squeeze bottle because he likes the flavor and has children who break glass jars frequently. No other mustard brand can be substituted but he is willing to consider different size plastic squeeze bottles. He also needs butter and prefers Land O'Lakes brand in one pound blocks but is willing to consider other brands on sale because he feels all butter tastes the same. He also needs vegetables, peas, corn and carrots. He prefers individual frozen sixteen ounce packages because he likes to store them separately but this time he is making stir fry and is willing to accept a frozen premix of them.

Influencers 600 access his preference information from the preference management system and develop plans to influence the consumer. The consumer can review the communication from influencers which pass his criteria via the alerts and filter processing module 900 to help him make a purchase decision saving time and effort while meeting his goals for product features. For example, the preference management engine will pass along an alert to the consumer regarding a current sale on Gulden brand mustard in a sixteen ounce plastic bottle. Information would be passed to the consumer regarding a newly available fresh vegetable mix of peas, corn and carrots for his consideration according to his rules while information regarding ground beef would not be communicated to the consumer based on the consumer preferences and rules defined in this example because it is not an item of interest. After accepting or rejecting proposed adjustments to his item list, the consumer moves onto purchasing the items by placing an order, paying and arranging for picking, packing and pick up at the local grocery store. A receipt is printed by the publishing module 700, the consumer's electronic calendar is updated to reflect that he will need to start dinner by 5:00 pm if he intends to have it ready by 6:00 pm on the next day and a task is entered into his mobile phone reminding him to pick up the groceries at 4:00 pm today. The preference management system then updates the financial software of the consumer records via the linked services module 800 identifying the money spent and then reports calorie count, fat consumed and fiber content for the week based on the meals selected for the period. Finally, the preference management system receives a notice from the heart doctor of the consumer via the external database interface 570 and passes along a reminder to keep fat consumption down for the next three weeks.

In other embodiments, the preference management system stores the consumer data such that anytime the consumer desires an item, as in this example, Gulden brand mustard, he only needs to identify it on his item list in the generic form, such as mustard. The preference management system will apply his stored preferences to the item such that only information relating to the preferred brand is displayed saving the consumer significant effort. Additionally, the consumer interface of the preference management system incorporates the ability to allow the consumer to assign his preferences to a third party who can act on behalf of the consumer, for example, by handling the grocery shopping, such that the consumer knows that his preferences will always be honored even in his absence. Furthermore, the preference management system may be used to create a list of items by searching for recipes based on items the consumer has on hand, allowing the consumer to select a recipe from those that pass the criteria defined by the consumer, and then automatically adding to the items of interest the list of missing items needed to create said recipe.

In yet another embodiment, the preference management system having information on what items are in the possession of the consumer and how often the consumer purchases said item can be configured to notify the consumer when the expected level of the item is low, e.g., milk, bread, etc. Similarly, the preference management system can be configured to alert the consumer under any number of conditions based on information contained within the system or information provided by an external source, e.g., pending product expiration dates, times for medication, product interaction warnings, product recalls, news alerts, hazard warnings, stock pricing and so on.

In other embodiments, the preference management system can be utilized to manage preferences for financial instruments such as stock and bonds, insurance, television shows, internet content, entertainment, health, medicine, lifestyle and automobiles.

What we claim is:

1. A method performed by a preference management system, the method comprising:
receiving, from a consumer, by the preference management system, information identifying an area or areas or item or items of interest;
receiving, from a consumer, by the preference management system, information identifying specific preferences and reasons for preferences;
receiving, from a consumer, by the preference management system, information identifying rules for passing information from an influencer or conditions allowed or required to consider changing preferences;
presenting, to an influencer, by the preference management system, said consumer areas of interest, preferences and conditions required to change preferences or rules pass on communication;
receiving, from an influencer, by the preference management system, product information, product updates, advertisements or other materials;
presenting, to a consumer, by the preference management system, the information identified which passes the consumer's defined rules and conditions.

2. The invention of claim 1, where the items of interest include political ideals, medical items, financial instruments, automobiles, electronics, commercial goods, lifestyle choices, groceries and consumer goods.

3. The invention of claim 1, where the item or items of interest consists of a grocery list.

4. The invention of claim 1, further comprising the steps whereby the consumer purchases the items.

5. The invention of claim 3, where the grocery list is derived automatically from a selection of recipes.

6. The invention of claim 3, where the items of interest are extracted from a recipe which is derived from a selection of items identified by the consumer.

7. The invention of claim 1, where feedback is provided to the consumer, by the preference management system, relating to the expected or actual state of the product via electronic means.

8. The invention of claim 1, where the preference management system presents to the consumer information to automatically update financial, calendar, calories, nutrient, health, and or medical information.
